(19) United States
(12) Patent Application Publication
(10) Pub. No.: US 2008/0045409 A1
(43) Pub. Date: Feb. 21, 2008

(54) Ceramic catalysts

(76) Inventor: Pedro M. Buarque de Macedo, Bethesda, MD (US)

Correspondence Address: AMSTER, ROTHSTEIN & EBENSTEIN LLP, 90 PARK AVENUE, NEW YORK, NY, 10016, US

(21) Appl. No.: 11/504,953

(22) Filed: Aug. 16, 2006

(51) Int. Cl. C03C 3/089; C03C 3/091; B01J 21/02

(52) U.S. Cl. 502/202; 501/65; 501/66

(57) ABSTRACT

Provided are ceramic catalysts comprising a borosilicate glass substrate having substantially interconnecting pores with an average pore size of approximately 1 micron or less and particles comprising one or more noble metals on the surface of the substantially interconnecting pores. Also provided are methods of manufacturing the ceramic catalyst, and glass compositions used to manufacture the ceramic catalyst.

### FIELD OF INVENTION

The present invention relates generally to a ceramic catalyst and a method of manufacturing the same. The present invention also generally relates to novel glass compositions and to glass articles particularly suitable for forming or being converted to ceramic catalyst.

### BACKGROUND OF THE INVENTION

Ceramic catalysts are commonly used to expedite gas phase chemical reactions, such as completing the oxidation of the exhaust fumes from a combustion engine. The catalyst involves a ceramic matrix that immobilizes noble metal colloids. The reaction chemicals, such as organics, pass through the ceramic; the reaction chemicals attach to the noble metal which can catalyze a reaction; the attachment increases the reaction (e.g., oxidation) rate; the resultant product molecules leave the noble metal. Ceramic catalysts are very common, for example every car has one in its exhaust system, typically with rhodium as the noble metal. Unfortunately, prior art catalysts have limited effectiveness for high processing rate applications because they have a relatively low surface to volume ratio.

In my prior U.S. Pat. No. 4,319,905, I disclosed suitable compositions for producing a porous glass substrate with an interconnected structure and a high surface volume, which is hereby incorporated by reference as if it is fully set forth herein. However, the porous glass substrate disclosed in my prior U.S. Pat. No. 4,319,905, was used for an optical wave guide, and was not suitable for use as a catalyst. For example, if the molecular stuffing techniques of the prior art were applied to the process disclosed in my U.S. Pat. No. 4,319,905 to add a noble metal, such as silver, to catalyze the reaction, the concentration of silver present in the resulting product would be too low to be useful as a catalyst. Thus, what is needed is an improved porous glass substrate in which silver and/or other noble metals can be added to form a useful catalyst.

It is an object of the invention is to increase the efficiency of ceramic catalysts while minimizing the cost.

It is also an object of the invention to increase the area of exposed catalyst metal for a given volume.

These and other objects will become apparent from the foregoing description.

### SUMMARY OF THE INVENTION

It has now been found that the above and related objects of the present invention are obtained in the form of ceramic catalyst having interconnecting pores with particles of colloids and/or nanocrystals comprising one or more noble metals on the surface of the interconnecting pores.

Some embodiments of the present invention are directed to ceramic catalysts comprising a borosilicate glass substrate having substantially interconnecting pores with an average pore size of approximately 1 micron or less and particles comprising one or more noble metal on the surface of the substantially interconnecting pores.

Other embodiments of the present invention are directed to noble metal alkali borosilicate glass compositions comprising approximately 48-64 mole % SiO₂, 28-42 mole % B₂O₃, 4-9 mole % R₂O, 0-3 mole % Al₂O₃, and 1-4 mole % MₓO_{y}, where R is one or more alkali metals, M is one or more noble metals, x varies between approximately 1 and approximately 2 and y varies between approximately 1 and approximately 5.

Additional embodiments of the present invention are directed to noble metal alkali borosilicate glass compositions comprising approximately 49.5-59 mole % SiO₂, 33-37 mole % B₂O₃, 5-8 mole % R₂O, 0-2 mole % Al₂O₃, and 1.5-2.5 mole % MₓO_{y}, wherein R is one or more alkali metals, M is one or more noble metals, x varies between approximately 1 and approximately 2 and y varies between approximately 1 and approximately 5.

Further embodiments of the present invention are directed to noble metal alkali borosilicate glass compositions comprising approximately 56 mole % SiO₂, 36 mole % B₂O₃, 3 mole % Na₂O, 3 mole % K₂O, and 2 mole % Ag₂O.

Additional embodiments of the present invention are directed to methods of manufacturing a ceramic catalyst comprising the steps of:
a) creating a mixture comprising a silicate, a boron, an alkali metal and a noble metal in forms suitable to form a noble metal alkali borosilicate glass;
b) melting the mixture at approximately 1400° C. and 1500° C. to form a viscous solution;
c) cooling the viscous solution without phase separating the viscous solution;
d) heat treating the viscous solution to phase separate the viscous solution into at least a silica rich phase and a silica poor phase comprising a noble metal;
e) cooling the phase separated viscous solution to form a glass; and
f) leaching the silica poor phase comprising a noble metal of the glass to form interconnecting pores in the glass so that at least some of the noble metal remains on a surface of the interconnecting pores.

Further embodiment of the present invention are directed to methods of manufacturing a ceramic catalyst comprising the steps of:
a) providing a ceramic catalyst having interconnecting pores with particles comprised of metallic silver on the surface of the interconnecting pores; and
b) forming a layer of gold on the particles.

### DETAILED DESCRIPTION OF THE INVENTION

The present invention generally relates to a ceramic catalyst and a method a making the same. The present invention also generally relates to novel glass compositions and to glass articles particularly suitable for forming or being converted to ceramic catalyst.

Thus, the invention is directed to ceramic catalysts comprising a borosilicate glass substrate having substantially interconnecting pores with an average pore size of approximately 1 micron or less and particles comprising one or more noble metal on the surface of the substantially interconnecting pores.

The particles in the pores of the catalysts can be of any known structure. Preferably, the particles are colloids or nanocrystals, or both.

The noble metal in these catalysts can be any known noble metal, including gold, silver, platinum, or rhodium. Preferably, the noble metal comprises gold, silver and/or rhodium. In more preferred embodiments, the noble metal comprises silver and gold. In some embodiments where the particles comprise silver, the particles are preferably coated with a layer of a second noble metal on a surface of the particles. Preferred second noble metals here are gold and rhodium.

The pores in the catalysts of the present invention are not limited to any particular size (i.e., pore diameter). Preferably, the average pore size is approximately 0.5 microns or less. In other preferred embodiments, the average pore size is approximately 0.3 microns or less. In additional preferred embodiments, the average pore size is approximately 0.2 microns or less. Preferably, there may be at least 1 weight % of the noble metal in the ceramic catalyst, more preferably at least 2 weight %, even more preferably at least 3 weight % of the noble metal in the ceramic catalyst.

The invention is also directed to a noble metal alkali borosilicate glass composition comprising approximately 48-64 mole % SiO₂, 28-42 mole % B₂O₃, 4-9 mole % R₂O, 0-3 mole % Al₂O₃, and 1-4 mole % MₓO_{y}, where R is one or more alkali metal, M is one or more noble metal, x varies between approximately 1 and approximately 2 and y varies between approximately 1 and approximately 5. Preferably, M comprises gold, silver and/or rhodium.

As used herein, alkali metals include lithium, sodium, potassium, rubidium or cesium.

In preferred embodiments of these glass compositions, wherein M comprises gold and silver, x is approximately 2 and y is approximately 1. In other preferred embodiments, wherein M comprises rhodium and x and y are approximately 1.

The present invention is additionally directed to noble metal alkali borosilicate glass compositions comprising 49.5-59 mole % SiO₂, 33-37 mole % B₂O₃, 5-8 mole % R₂O, 0-2 mole % Al₂O₃, and 1.5-2.5 mole % MₓO_{y}, where R is one or more alkali metals, M is one or more noble metals, x varies between approximately 1 and approximately 2 and y varies between approximately 1 and approximately 5. Preferred M for these compositions comprises gold, silver and/or rhodium. In other preferred embodiments, M comprises gold and/or silver, x is approximately 2 and y is approximately 1. In additional preferred embodiments, M comprises rhodium and x and y are approximately 1.

The invention is additionally directed to a noble metal alkali borosilicate glass compositions comprising approximately 56 mole % SiO₂, 36 mole % B₂O₃, 3 mole % Na₂O, 3 mole % K₂O, 2 mole % Ag₂O.

The invention is further directed to methods of manufacturing a ceramic catalyst. The methods comprise the steps of:
a) creating a mixture comprising a silicate, a boron, an alkali metal and a noble metal in forms suitable to form a noble metal alkali borosilicate glass;
b) melting the mixture at approximately 1400° C. and 1500° C. to form a viscous solution;
c) cooling the viscous solution without phase separating the viscous solution;
d) heat treating the viscous solution to phase separate the viscous solution into at least a silica rich phase and a silica poor phase comprising a noble metal;
e) cooling the phase separated viscous solution to form a glass; and
f) leaching the silica poor phase comprising a noble metal of the glass to form interconnecting pores in the glass so that at least some of the noble metal remains on a surface of the interconnecting pores.

In these embodiments, the noble metal is added at step a. or step b.

In some embodiments of these methods of manufacturing, the noble metal comprises silver. In these embodiments, the raw material mixture of step a) can comprise, for example, silver nitrate and/or silver chloride. The method can also comprise exposing the glass to light. The method can additionally comprise grounding and sieving the glass prior to leaching. Further discussion of these methods is provided below.

Further embodiments of the present invention are directed to additional methods of manufacturing a ceramic catalyst. These methods comprise the steps of:
a) providing a ceramic catalyst having interconnecting pores with particles comprised of metallic silver on the surface of the interconnecting pores; and
   forming a layer of gold on the particles.

In some preferred embodiments of the present invention, the ceramic catalyst comprises a ceramic substrate having substantially interconnecting pores, with particles of colloids and/or nanocrystals of one or more noble metals on a surface of the interconnecting pores.

In order to achieve a satisfactory ceramic substrate having substantially interconnecting pores it is necessary to choose a phase-separable composition, which on heat treatment at a particular temperature separates into approximately equal volume fractions, and when held at that temperature, develops a substantially interconnecting structure with a desirable pore size. While every pore does not need to be interconnected, a sufficient percentage of the pores need to be interconnected to enable fluid in either gas and/or liquid phases to flow or diffuse therethrough. The present invention utilizes the method of manufacturing a phase-separable borosilicate glass disclosed in my prior U.S. Pat. No. 4,319,905 discussed above, as modified by the teachings discussed herein. Preferred compositions of alkali borosilicate glass as the starting material for such a substrate as set forth in my prior U.S. Pat. No. 4,319,905 include the following ranges of elements in mole % as set forth in Table 1 herein:

TABLE 1

| | Broad | Preferred |
|---|---|---|
| SiO₂ | 48–64 | 49.5–59 |
| B₂O₃ | 28–42 | 33–37 |
| R₂O | 4–9 | 6.5–8 |
| Al₂O₃ | 0–3 | 0–2.0 |

wherein R refers to one or more alkali metals.

The present invention seeks to form a ceramic catalyst by improving upon these prior art structures by depositing a noble metal, such as silver and/or gold, on the substantially interconnecting surface areas. However, prior art techniques of stuffing interconnecting pores using, e.g., silver nitrate to form silver atoms on the interconnecting surfaces of the glass substrate after leaching, are inadequate to achieve a useful catalyst, since the silver atoms will dissolve during catalysis and thus will not be available for a second reaction. This technique is useful for forming an ion exchange as discussed, for example, in my prior U.S. Pat. No. 4,659,477, but is not suitable for use as a catalyst in accordance with the present invention.

The present invention modifies the prior art method and composition disclosed in my prior art patents, by incorporating one or more noble metals in the glass composition prior to phase separation, such that the ceramic catalyst is comprised of an alkali borosilicate glass, having substantially interconnecting pores, with particles of colloids and/or nanocrystals of one or more noble metals on the surface of the interconnecting pores as discussed herein.

The ceramic catalysts of the present invention are preferably manufactured from a glass composition comprising a noble metal alkali borosilicate glass, which simultaneously addresses problems associated with prior art ceramic catalysts. In accordance with an embodiment of the present invention, an initial glass composition for the ceramic catalyst is chosen to have the following characteristics:
The composition can be phase separated into at least two phases including a silica rich phase and a silica poor phase;
The viscosity of the composition is sufficiently high at the coexistence temperature (i.e., the highest temperature at which the composition first phase separates at equilibrium) that one can cool the glass through the coexistence temperature without phase separation;
The composition at a temperature below the coexistence temperature has a phase separation in which the silica rich phase and the silica poor phase have approximately the same volume;
The silica rich phase and the silica poor phase are substantially interconnected;
The average phase size is approximately 1.0 microns or less, and more preferably approximately 0.5 microns or less, and even more preferably approximately 0.3 microns or less, and even more preferably approximately 0.2 microns or less. The average phase size is measured by, for example, taking a electron micrograph or other similar photograph of a cross section of the porous structure, passing a line representing a particular length, e.g., representing 5 microns, through a picture, counting the number of phase boundaries that the line intersect, and dividing the representative length of the line by the number of intersected phase boundaries to obtain the average phase size. This process can be repeated with one or more additional lines in different directions on the micrograph or photograph to verify the results; and
The silica poor phase is soluble in the appropriate solvent, and the silica rich phase is not.

The present invention provides a way to use the large surface areas available from the leached phase separated glasses to be useful catalysts, by substituting monovalent (or divalent) noble metals with particles of colloids and/or nanocrystals comprising one or more noble metals. Prior art techniques of doping leached phase separated glasses to add noble metal atoms on the interconnected surface areas are not practical or economically feasible to form particles of colloids and/or nanocrystals comprised of one or more noble metals on the interconnected surface areas, as noted above.

The present invention solves this problem by dissolving one or more noble metals in the molten glass prior in the beginning of the formation process and phase separation. This can be achieved by modifying the composition of the alkali borosilicate glass to include the following ranges of elements in mole % as set forth in Table 2 herein:

TABLE 2

| | Broad | Preferred |
|---|---|---|
| SiO₂ | 48–64 | 49.5–59 |
| B₂O₃ | 28–42 | 33–37 |
| R₂O | 4–9 | 5–8 |
| Al₂O₃ | 0–3 | 0–2.0 |
| MₓO_{y} | 1–4 | 1.5–2.5 |

where R refers to one or more alkali metals and M refers one or more noble metals, and x and y are selected based on the appropriate valence of the selected noble metals. Typically x varies between approximately 1 and approximately 2 and y varies between approximately 1 and approximately 5. Examples of alkali metals that can be used as R include lithium, sodium, potassium, rubidium, cesium. In a preferred embodiment, sodium and/or potassium are used. Examples of noble metals that can be used as M, include rhodium, palladium, silver, iridium, platinum, gold. In a preferred embodiment, silver and/or gold are used, in which case x is approximately 2 and y is approximately 1. In another embodiment, rhodium may also be used in conjunction with or instead of silver and gold, in which case x and y for the rhodium compound are approximately 1.

In one preferred embodiment of the present invention, silver is used to form the majority of the weight and/or volume of particles of the colloids and/or nanocrystal. Ceramic catalysts having particles of colloids and/or nanocrystals comprising silver are preferably formed as follows:
a) Raw materials are selected and weighed in accordance with the recipes set forth in Table 2 hereof, wherein the alkali metals are carbonates and noble metal is silver to form a composition of silver alkai borosilicate. For example, an appropriate composition would include 56 mole % SiO₂, 36 mole % B₂O₃, 3 mole % Na₂O, 3 mole % K₂O, 2 mole % Ag₂O. Ag₂O may be also be first introduced into the composition by using, e.g., AgCl.
b) The raw materials are melted at a temperature above coexistence temperature, e.g., approximately between 1400° C. and 1500° C., in, e.g., a platinum crucible. Stir appropriately while melting.
c) The glass is cooled quickly to room temperature without phase separation;
d) The glass is ground and sieved preferably so it passes 40 mesh and does not pass 100 mesh;
e) The glass is then heat treated appropriately to phase separate, e.g., at approximately 550° C. for 1.5 hours. Silver accumulates in the silica poor phase, effectively doubling its concentration from the starting composition.
f) The phase separated glass is cooled to approximately room temperature.
g) In a preferred embodiment, the glass is exposed to light containing UV radiation until the glass turns black, an indication that the silver has precipitated as metallic colloid and/or nanocrystal.
h) The blackened glass is leached in a solution comprising approximately 95° C. HCl. In some embodiments, step g) is performed and/or repeated either prior to, during or after the leaching process so that the glass after leaching is black in color;
i) The glass is washed with deionized water;
j) The glass is dried.

By following this process, a ceramic catalyst having substantially interconnecting pores with a large surface area, and metallic colloid and/or nanocrystal silver on the surface of the interconnecting pores is formed.

In other embodiments of the present invention, a layer of a second noble metal, such as gold, is formed on the surface of the particles of metallic colloid and/or nanocrystal comprised of a first noble metal, such as silver, which are on the surface of the interconnecting pores of the ceramic catalyst. Preferably, the second noble metal has a lower oxidation state than the first noble metal.

An example of a ceramic catalyst in accordance with these embodiments of the present invention can be made as follows:
a) A ceramic catalyst is provided having interconnecting pores with particles of metallic colloid and/or nanocrystal comprising silver (and/or another noble metal) on the surface of the interconnecting pores, such as described above;
b) The ceramic catalyst is submerged into a solution containing gold, such as a solution comprising AuNO₃ at, e.g., room temperature.
c) The submergence of the ceramic catalyst continues until the concentration of gold in the solution substantially stops decreasing and the silver concentration in solution substantially stops increasing. It may be necessary to replenish the solution if the gold concentration decreases too much.
d) The glass is washed with deionized water;
e) The glass is dried.

By following this process, a ceramic catalyst having substantially interconnecting pores with a large surface area, and particles of metallic colloid and/or nanocrystal comprised of silver on the surface of the interconnecting pores is formed, with a second metallic layer of comprised of gold coating the surface of the silver particles.

Now that the preferred embodiments of the present invention have been shown and described in detail, various modifications and improvements thereon will become readily apparent to those skilled in the art. For example, the same procedure can be done with other noble metals, such as, rhodium nitrate which is also soluble. For high temperature applications rhodium may be the preferred noble metal, even though it is much more expensive than gold. Accordingly, the spirit and scope of the present invention is to be construed broadly and limited only by the appended claims and not by the foregoing specification.

What is claimed is:

1. A ceramic catalyst comprising a borosilicate glass substrate having substantially interconnecting pores with an average pore size of approximately 1 micron or less and particles comprising one or more noble metal on the surface of the substantially interconnecting pores.

2. The ceramic catalyst of claim 1, wherein the particles are colloids.

3. The ceramic catalyst of claim 1, wherein the particles are nanocrystals.

4. The ceramic catalyst of claim 1, wherein the particles are colloids and nanocrystals.

5. The ceramic catalyst of claim 1, wherein the one or more noble metal comprises silver.

6. The ceramic catalyst of claim 1, wherein the one or more noble metal comprises gold.

7. The ceramic catalyst of claim 1, wherein the one or more noble metal comprises rhodium.

8. The ceramic catalyst of claim 1, wherein the one or more noble metal comprises silver and gold.

9. The ceramic catalyst of claim 5, wherein the particles are coated with a layer of a second noble metal on a surface of the particles.

10. The ceramic catalyst of claim 9, wherein the second noble metal is gold.

11. The ceramic catalyst of claim 9, wherein the second noble metal is rhodium.

12. The ceramic catalyst of claim 1, wherein the average pore size is approximately 0.5 microns or less.

13. The ceramic catalyst of claim 1, wherein the average pore size is approximately 0.3 microns or less.

14. The ceramic catalyst of claim 1, wherein the average pore size is approximately 0.2 microns or less.

15. A noble metal alkali borosilicate glass composition comprising approximately 48-64 mole % SiO₂, 28-42 mole % B₂O₃, 4-9 mole % R₂O, 0-3 mole % Al₂O₃, and 1-4 mole % MₓO_{y}, wherein R is one or more alkali metals, M is one or more noble metals, x varies between approximately 1 and approximately 2 and y varies between approximately 1 and approximately 5.

16. The noble metal alkali borosilicate glass composition of claim 15, wherein M comprises gold, silver or rhodium.

17. The noble metal alkali borosilicate glass composition of claim 15, wherein M comprises gold and silver and x is approximately 2 and y is approximately 1.

18. The noble metal alkali borosilicate glass composition of claim 15, wherein M comprises rhodium and x and y are approximately 1.

19. A noble metal alkali borosilicate glass composition comprising approximately 49.5-59 mole % SiO₂, 33-37 mole % B₂O₃, 5-8 mole % R₂O, 0-2 mole % Al₂O₃, and 1.5-2.5 mole % MₓO_{y} wherein R is one or more alkali metals, M is one or more noble metals, x varies between approximately 1 and approximately 2 and y varies between approximately 1 and approximately 5.

20. The noble metal alkali borosilicate glass composition of claim 19, wherein M comprises gold, silver or rhodium.

21. The noble metal alkali borosilicate glass composition of claim 19, wherein M comprises gold and silver and x is approximately 2 and y is approximately 1.

22. The noble metal alkali borosilicate glass composition of claim 19, wherein M comprises rhodium and x and y are approximately 1.

23. A noble metal alkali borosilicate glass composition comprising approximately 56 mole % SiO₂ 36 mole % B₂O₃, 3 mole % Na₂O, 3 mole % K₂O, 2 mole % Ag₂O.

24. A method of manufacturing a ceramic catalyst comprising the steps of:
a. creating a mixture comprising a silicate, a boron, an alkali metal and a noble metal in forms suitable to form a noble metal alkali borosilicate glass;
b. melting the mixture at approximately 1400° C. and 1500° C. to form a viscous solution;
c. cooling the viscous solution without phase separating the viscous solution;
d. heat treating the viscous solution to phase separate the viscous solution into at least a silica rich phase and a silica poor phase comprising a noble metal;
e. cooling the phase separated viscous solution to form a glass; and
f. leaching the silica poor phase comprising a noble metal of the glass to form interconnecting pores in the glass so that at least some of the noble metal remains on a surface of the interconnecting pores.

25. The method of manufacturing a ceramic catalyst according to claim 24, wherein the noble metal comprises silver.

26. The method of manufacturing a ceramic catalyst according to claim 25, wherein the noble metal is provided as silver nitrate.

27. The method of manufacturing a ceramic catalyst according to claim 25, wherein the noble metal is provided as silver chloride.

28. The method of manufacturing a ceramic catalyst according to claim 25, wherein the glass is exposed to light between and/or during steps e. and/or f.

29. The method of manufacturing a ceramic catalyst according to claim 24, wherein prior to leaching the glass is ground and sieved.

30. A method of manufacturing a ceramic catalyst comprising the steps of:
a. providing a ceramic catalyst having interconnecting pores with particles comprised of metallic silver on the surface of the interconnecting pores; and
b. forming a layer of gold on the particles.
